(19) United States
(12) Patent Application Publication
(10) Pub. No.: US 2016/0118932 A1
(43) Pub. Date: Apr. 28, 2016

(54) STOWAGE SYSTEM FOR A CONNECTOR OF A PHOTOVOLTAIC COMPONENT

(71) Applicant: DOW GLOBAL TECHNOLOGIES LLC, Midland, MI (US)

(72) Inventors: James R. KEENIHAN, Midland, MI (US); Leonardo C. LOPEZ, Midland, MI (US); Shane WASHBURN, Oakland, CA (US); Darius EGHBAL, Oakland, CA (US); Vijay Karthik KONERU, Santa Clara, CA (US); Kelvin L. LEUNG, Mountain View, CA (US)

(21) Appl. No.: 14/898,609

(22) PCT Filed: Jun. 9, 2014
(86) PCT No.: PCT/US2014/041479

§ 371 Date: Dec. 15, 2015

Related U.S. Application Data
(60) Provisional application No. 61/856,119, filed on Jul. 19, 2013.

(51) Int. Cl. H02S 30/10; H01R 43/16; H01R 13/73

(52) U.S. Cl. CPC H02S 30/10; H01R 13/73; H01R 43/16

(57) ABSTRACT

A photovoltaic component comprising: an integral electrical connector; a protective stowage pocket that houses at feast a portion of the electrical connector during a storage position so that the electrical connector is protected when in an uninstalled position; wherein the electrical connector is movable from the protective stowage pocket to an electrical connection position where the electrical connector electrically connects the photovoltaic component to an adjacent photovoltaic component,?

### STATEMENT OF GOVERNMENT RIGHTS

This invention was made at least in part with U.S. Government support under contract number DE-EE0004434 awarded by the Department of Energy. The U.S. Government has certain rights in this invention.

### FIELD

The present teachings generally relate to an improved stowage system for housing movable components and specifically a stowage system that houses at least a portion of an electrical connector during a storage position so that the electrical connector is protected when in an uninstalled position.

### BACKGROUND

Typically, photovoltaic arrays are placed in an outdoor location so that the photovoltaic arrays are exposed to sunlight. During assembly of the photovoltaic arrays the photovoltaic components are each individually moved to a support location and assembled. The photovoltaic components may include integral connection pieces and during transportation the integral connection pieces of the photovoltaic components may move, become damaged, disconnect from the photovoltaic component, get lost, or a combination thereof. Other photovoltaic components may be connected by discrete connectors that may be separately transported to the installation location and then installed in the photovoltaic components. These discrete connectors may be lost, not enough connectors may be transported to the installation location and more trips may be required, more connectors then required may be transported and then subsequently lost or damaged, or a combination thereof. Once at a desired location the photovoltaic components are generally placed in a support structure that houses each of the photovoltaic components so that the photovoltaic components form a photovoltaic array. Further, individual photovoltaic components making up the photovoltaic array may be directly connected to a support structure such as a roof of a house or a building. Once connected to the support structure, the photovoltaic components may be electrically connected to each other using the connection pieces so that the photovoltaic array is formed.

Once installed, the components of the photovoltaic array are subjected to varying conditions such as wind, rain, snow, ice, heat, and direct sunlight. The changes in ambient conditions such as temperature, humidity, and precipitation may cause the components of the photovoltaic array and/or support structure to expand, contract, move, or a combination thereof in addition to a mass being applied to the photovoltaic components, a mass being applied to the support structure, or both such that each of the photovoltaic components may move relative to each other. This movement may cause a connector between two adjacent photovoltaic components to become disconnected from one or both of the photovoltaic components, be broken, a terminal to be broken, or a combination thereof so that less than all of the photovoltafc modules in the photovoltaic array are connected and produce power.

Examples of some known connectors may be found in U.S. Pat. Nos. 7,442,077; 7,963,773; and 8,414,308; U.S. Patent Application Publication No. 2010/00258157; 20110220180; and 2011/0183540; European Patent No. EP2256872; and International Patent Application Nos. WO2012/044762 and WO2012/154307 all of which are incorporated by reference herein for all purposes.

It would be attractive to have one or more integral connectors built into each photovoltaic component so that discrete connectors are not required form an electrical connection. It would be attractive to have an integral connector that is located and protected by a stowage pocket so that during transportation of a photovoltaic component the integral connectors are protected. What is needed is a stowage pocket that houses substantially all of one or more integral connectors so that during transportation the connectors are protected and during installation the integral connectors are extendable from the stowage pockets so that a connection is formed between two adjacent photovoltaic components. What is needed is a stowage pocket that houses an integral connector and allows the integral connector to move with the photovoltaic components as they move, expand, contract, or a combination thereof so that an electrical connection is maintained.

### SUMMARY

The present teachings meet one or more of the present needs by providing: a photovoltaic component comprising: an integral electrical connector; a protective stowage pocket that houses at least a portion of the electrical connector during a storage position so that the electrical connector is protected when in an uninstalled position; wherein the electrical connector is movable from the protective stowage pocket to an electrical connection position where the electrical connector electrically connects the photovoltaic component to an adjacent photovoltaic component.

The present teachings provide a photovoltaic array comprising: a plurality of the photovoltaic components of the teachings herein, wherein some of the plurality of photovoltaic components are photovoltaic modules.

The present teachings provide a method of installing the photovoltaic component of the teachings herein: (a) aligning two or more photovoltaic components adjacent to each other; (b) pulling the electrical connector from the protective stowage pocket and extending the electrical connector over an adjacent photovoltaic component; and (c) forming an electrical connection between the photovoltaic component and the adjacent photovoltaic component.

The teachings herein provide one or more integral connectors that are built into each photovoltaic component so that discrete connectors are not required to form an electrical connection. The teachings herein provide an integral connector that is located and protected by a stowage pocket so that during transportation of a photovoltaic component the integral connectors are protected. The teachings herein provide a stowage pocket that houses substantially all of one or more integral connectors so that during transportation the connectors are protected and during installation the integral connects are extendable from the stowage pockets so that a connection is formed between two adjacent photovoltaic components. The teachings herein provide a stowage pocket that houses an integral connector and allows the integral connector to move with the photovoltaic components as they move, expand, contract, or a combination thereof so that an electrical connection is maintained.

### BRIEF DESCRIPTION OF THE DRAWINGS

FIGS. 1A, 1B, 1C, and 1D illustrate a connection sequence with an electrical connector extending from a protective stowage pocket;

FIGS. 2A, 2B, and 2C illustrate a physical connection and electrical sequence from another possible protective stowage pocket of the teachings herein;

FIGS. 2D1, 2D2, and 2E illustrate exploded views of the device of the teachings herein;

FIGS. 3A, 3B, and 3C illustrate a connection sequence using another electrical connector and protective stowage pocket of the teachings herein; and

FIGS. 4A and 4B illustrates an example of another embodiment of the protective stowage pocket and electrical connector.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. The present application claims priority to U.S. Provisional Patent Application No. 61/856,119, filed on Jul. 19, 2013 the teachings of which are incorporated by reference herein in their entirety for all purposes.

A plurality of photovoltaic modules and/or photovoltaic components (i.e., solar components) of the teachings herein are combined together to form a photovoltaic array (also sometimes referred to as a solar array). The photovoltaic array collects sunlight and converts the sunlight to electricity. Generally, each of the photovoltaic modules may be individually placed in a structure that houses all of the photovoltaic modules forming all or a portion of a photovoltaic array. The photovoltaic modules of the teachings herein may be used with a housing that contains all of the individual photovoltaic modules that make up a photovoltaic array. Preferably, the photovoltaic array taught herein is free of a separate structure that houses all of the photovoltaic modules that make up a photovoltaic array. More preferably, each individual photovoltaic module may be connected directly to a structure and each of the individual photovoltaic modules is electrically connected together so that a photovoltaic array is formed (i.e., a building integrated photovoltaic (BIPV)). Each of the photovoltaic components, and preferably each row of photovoltaic components in the photovoltaic array may be adjacent to each other in a first direction. For example, if a photovoltaic array includes three rows of photovoltaic components and each row includes 5 photovoltaic components, each of the rows and each of the 5 photovoltaic components within the rows may extend along a first direction. The first direction may be aligned with the slope of a roof. Preferably, the first direction is a transverse direction (i.e., perpendicular to the slope of the roof). A portion of each of the photovoltaic modules may overlap a portion of an adjacent photovoltaic module, an adjacent photovoltaic component, or both forming a shingle configuration and/or a double overlap configuration on a support structure so that the photovoltaic modules may be used as roofing shingles. Preferably, at least a portion of one photovoltaic component is in contact with an adjacent photovoltaic component so that a contiguous surface is formed, the photovoltaic components are interconnected, or both.

The photovoltaic components of the photovoltaic array may be any photovoltaic component that collects sunlight to generate electricity, any component that transfers power throughout the photovoltaic array, a photovoltaic module, any component that assists in generating energy from sunlight, an integrated flashing piece, an inverter connection, an inverter, a connector, or a combination thereof. Preferably, the photovoltaic components are a photovoltaic module, an integrated flashing piece, or both. More preferably, at least one of two photovoltaic components is a photovoltaic module. The photovoltaic components may include a laminate assembly, an electric assembly, a photovoltaic housing, or a combination thereof. The photovoltaic components may be connected together by a connector component that is discrete from each photovoltaic component, integrally connected to one photovoltaic component and separate from another photovoltaic component, partially integrally connected to each photovoltaic component, or a combination thereof. Preferably, the photovoltaic components each include one or more connectors so that two or more adjacent and/or juxtaposed photovoltaic components may be electrically connected together. For example, the two adjacent photovoltaic components may be located in close proximity to each other (i.e., a spacer, gap, shim, or the like may be located between the two adjacent photovoltaic components) so that a connector may span between and electrically connect the two adjacent photovoltaic components. The photovoltaic components, adjacent photovoltaic components, or both may be the same components, different components, or combinations of photovoltaic components of the teachings herein located next to each other, side by side, juxtaposed, in a partially overlapping relationship, or a combination thereof. As discussed herein an adjacent photovoltaic component may be any component taught herein that assists in creating a photovoltaic array so that power is generated from sunlight. The solar array may include a plurality of photovoltaic components. Preferably, at least some of the plurality of photovoltaic components are photovoltaic modules. A majority of the photovoltaic components and/or adjacent photovoltaic components in the photovoltaic array may be photovoltaic modules such that 50 percent or more, 60 percent or more, or even 70 percent or more of the photovoltaic components are photovoltaic modules. As discussed herein a photovoltaic component and an adjacent photovoltaic component may be the same type of component just located side by side. The photovoltaic components when located side by side may form a mating connection, a physical connection, an electrical connection, or a combination thereof.

The mating connection, the physical connection, or both may be formed by one or more mating features, the electrical connections of the teachings herein, or both. The mating connection may be any connection where two or more photovoltaic modules are physically connected together. The mating connection may be only an electrical connection, only a physical connection or both. The mating connection may be formed by a male portion, a female portion, or both. The male portion may be any feature and/or device that extends from one photovoltaic component to an adjacent photovoltaic component. The female portion may be any feature and/or device that receives a portion that extends from an adjacent photovoltaic component (e.g., a male portion). The mating features may be any feature that aligns the photovoltaic components, edges of the photovoltaic components, or both.

The photovoltaic components may have a primary edge length dimension. The primary edge length dimension may be any dimension of the photovoltaic component so that the photovoltaic component may be used to produce electricity. Preferably, the primary edge length dimension of the photovoltaic component is a length. The length is the dimension that runs from photovoltaic component to photovoltaic component along a row (i.e., perpendicular to the slope of a roof and/or transverse to the support structure). The primary edge length dimension may be about 50 cm or more, preferably about 75 cm or more, more preferably about 85 cm or more, or even about 100 cm or more. The primary edge length dimension may be about 3 m or less, about 2 m or less, or about 1.5 m or less. The photovoltaic component includes a secondary edge length dimension. The secondary edge length dimension may be any dimension of the photovoltaic component so that the photovoltaic component may be used to produce electricity. Preferably, the secondary edge length dimension is a width. The width is a dimension that is substantially perpendicular to the primary edge length dimension. For example, the width runs in the direction of the slope of a roof (i.e., longitudinal direction of the roof). The secondary edge length dimension may be about 30 cm or more, preferably about 45 cm or more, about 60 cm or more, or even about 75 cm or more. The secondary edge length dimension may be about 2 m or less, about 1.5 m or less, or about 1 m or less. Each photovoltaic component includes a photovoltaic housing that encases all or a portion of an electric assembly, buss bars, electric connectors, or a combination thereof.

The photovoltaic housing may be any part of the photovoltaic component that contains, holds, houses, or a combination thereof one or more movable components, movable features, active features, electric components, or a combination thereof. The photovoltaic housing may protect, water proof, or both, one or more components located within the photovoltaic housing. The photovoltaic housing may include one or more front layers, one or more back layers, or both that protect the internal components from impact, fluids, or both. One or more encapsulant layers may be located under the one or more front layers, one or more back layers, or both. The overall dimensions of the photovoltaic housing may be the same as the dimensions of the photovoltaic component. The dimensions of the photovoltaic component define an area of a top and bottom of the photovoltaic component.

Each of the photovoltaic components include a top and a bottom. The top is the side of the photovoltaic component that faces the sun and the bottom is the side of the photovoltaic component that faces the support structure (e.g., roof decking of a home or building). Generally the top and the bottom are substantially parallel. Each of the photovoltaic components include one or more edge regions. Typically, each photovoltaic component is generally rectangular and includes four edge regions. However, depending on the size and shape of the photovoltaic component, the photovoltaic component may include two or more, three or more, five or more, or even six or more edge regions. The edge region may be any part of the photovoltaic component where the photovoltaic component terminates. The edge region may be a part of the photovoltaic component where an active portion, an inactive portion, or both end. The edge region may be generally parallel to one or more adjacent edge regions, generally perpendicular to one or more adjacent edge regions, may include a portion that protrudes out from the remainder of the edge region, may be a portion of a photovoltaic component that contacts an adjacent photovoltaic component, or a combination thereof. Preferably, an edge region is located directly across from an opposing edge region. The edge region may be a frame that extends around a periphery of a photovoltaic component. The edge region may have a width of about 10 cm or less, about 8 cm or less, or about 5 cm or less. The edge region may have a width of about 1 cm or more, about 2 cm or more, or about 3 cm or more. The dimensions of the edge region may vary along the length of the edge region. For example, one or more electrical connections may extend from an edge region so that the edge region is widened proximate to the electrical connections. The one or more edge regions may be part of an active portion and inactive portion, or both.

Some and/or all of the photovoltaic components may include an inactive portion, an active portion, or both. Preferably, if the photovoltaic component is a photovoltaic module, the photovoltaic module includes both an active portion and an inactive portion. The active portion may be any portion that when contacted by sunlight produces electricity. The active portion may include an electrical assembly. The electrical assembly may include one or more buss bars, one or more electrical connectors that connect to the one or more buss bars, one or more photovoltaic cells, or a combination thereof. The active portion may overlap all or a portion of an edge region, a portion of the edge region and the central region, an inactive portion, or a combination thereof of an adjacent photovoltaic component. Preferably, the active portion overlaps an inactive portion of an adjacent photovoltaic component. More preferably, the active portions substantially cover the inactive portions of one or more of the adjacent photovoltaic components. However, one or more electrical connectors, one or more protective stowage pockets, or both may extend from and/or be located within the active portion, the inactive portion, or both and be covered by and/or cover all or a portion of an adjacent photovoltaic module. The inactive portion, the active portion, a location where the inactive portion and the active portion meet, or a combination thereof may include an electrical connector, a protective stowage pocket or both. The active portion, the inactive portion, a location where the inactive portion and the active portion meet, or a combination thereof may include one or more potting wells, one or more buss bars, or both.

The one or more buss bars may be any device that assists in transporting power. The one or more buss bars may be extend from one edge region to an opposing edge region of a photovoltaic component. The one or more buss bars may be used to electrically connect two or more photovoltaic components; extend through the inactive portion, the active portion, the area connecting the inactive portion and the inactive portion, or a combination thereof; transport power through the photovoltaic array to the inverter; from one or more photovoltaic components to another photovoltaic component; collect power from one or more photovoltaic components; transport power through the active portion; or a combination thereof. The one or more buss bars may terminate in one or more edge regions, in a potting well, proximate to a protective stowage pocket, or a combination thereof.

The one or more potting wells may be any device that houses one or more buss bars, one or more electrical connections, connects the one or more buss bars to the one or more electrical connections, or a combination thereof. The one or more potting wells may provide a space (e.g., a stowage recess) for one or more electrical connectors to move, expand, contract, or a combination thereof so that a connection may be formed, maintained, or both between two or more photovoltaic components. The one or more potting wells may be a pocket, a stowage recess, an absence of material, or a combination thereof where the one or more electrical connectors connect to the one or more buss bars and the potting wells provides additional space for the one or more electrical connectors to be coiled, accordioned, folded, or a combination thereof so that the one or more electrical connections are protected when retracted into the one or more potting wells, the one or more protective stowage pockets, covering the one or more potting wells, or both. The one or more potting wells may be a storage recess for storing additional length of the electrical connector within the one or more protective stowage pockets so that substantially all of the electrical connector is located within the protective stowage pocket when the electrical connector is in a stored position, an uninstalled position, or both.

The one or more protective stowage pockets may be any device that covers, houses, holds, or a combination thereof all or a portion of one or more electrical connectors. The protective stowage pocket may be any device and/or feature that retains and/or protects an electrical connector in an uninstalled position (e.g., any position where the electrical connector is not forming an electrical connection). The one or more protective stowage pockets may be any device that protects all or a portion of the electrical connectors from damage. The one or more protective stowage pockets may be any device that retains an electrical connector in a stored position (i.e., a position where the electrical connector is substantially prevented from moving when in an uninstalled position). The protective stowage pocket may form a releasable connection with all or a portion of the one or more electrical connectors. The protective stowage pockets may be configured so that all or a portion of one or more electrical connectors is stored within the protective stowage pocket during transportation and at least a portion of the electrical connector is extendable out of the protective stowage pocket so that a connection is formed with an adjacent photovoltaic component. The one or more protective stowage pockets may be integrally formed in a photovoltaic component. For example, the protective stowage pocket may be a recess in the active portion, the inactive portion, or both that houses one or more electrical connectors. The protective stowage pocket may be a separate piece that is added to a photovoltaic component after the photovoltaic component is formed. The protective stowage pocket may be fixed, movable, include a movable portion, include a movable component, or a combination thereof. The protective stowage pocket may be raised, recessed, flush, or a combination thereof with the rest of the photovoltaic component. The protective stowage pocket may be in an edge region, in a central region, proximate to an end region, or a combination thereof. Preferably, the protective stowage pocket sufficiently confines one or more electrical connectors so that the electrical connectors are prevented from moving during transportation. The protective stowage pocket may include one or more tracks.

The one or more tracks may be any device that assists the electrical connector in extending and/or retracting within the protective stowage pocket. The tracks may extend along an inner location on opposing sides of the protective stowage pocket. The tracks may be a complementary feature and/or device to a feature and/or device on an electrical connector, a connector slide cover, or both. The tracks may be a groove that receives a tongue, a projection, or both on a connector slide cover so that the connector slide cover assists in extending and retracting the electrical connector. The protective stowage pocket may include one or more locking mechanisms.

The one or more locking mechanisms may be any device and/or feature that fixedly connects, removably connects, or both the electrical connectors to the protective stowage pocket, in the protective stowage pocket, or both. The one or more locking mechanism may require a tool to remove the electrical connector from the protective stowage pocket, may be a user interface that requires an affirmative removal step by a user, use a lock release feature, or a combination thereof. The locking mechanism may form a locked connection in a storage position, an extended position, a connected position, or a combination thereof. The locking mechanism may be removed by a built in lock release feature. The lock release feature may be any feature that may release the locking mechanism, bias the locking mechanism so that the electrical connectors may be removed from the protective stowage pocket, or both. The locking mechanism may lock the electrical connector in an extended position so that a retraction feature is preventing from retracting all or a portion of the electrical connector back into the protective stowage pocket. The locking mechanism may be part of a connector slide cover, part of a retraction feature, or both.

The connector slide cover may be any feature and/or device that may assist in extending and/or retracting the electrical connectors. The connector slide cover may protect the electrical connector, the flexible housing, the flexible conductors, or both. The connector slide cover may include one or more projections that extend from one or more sides of the connector slide cover to assist the electrical connector in extending and retracting. The one or more projections may provide a complementary fit with one or more features of the protective stowage pocket, a track, or both. The one or more projections may provide a sliding surface for the connector slide cover to slide along so that the electrical connector may be moved from the protective stowage pocket to form an electrical connection with an adjacent photovoltaic component as taught herein. The one or more connector slide covers may form a connection with the protective stowage pocket, a retraction feature, or both so that the connector slide cover assists in extending and retracting the electrical connector to an installed position.

The retraction feature may be any device that provides tension and/or movement to the one or more electrical connectors so that the electrical connectors may be retracted into the protective stowage pocket, retained within the protective stowage pocket, extended with movement of the adjacent photovoltaic components in one direction and retracted with movement of the adjacent photovoltaic components in an opposing direction, or a combination thereof. The retraction feature may be any device that biases the one or more electrical connectors so that the one or more electrical connectors are moved into the protective stowage pocket, retained within the protective stowage pocket, are prevented from falling out of the protective stowage pocket, or a combination thereof. The one or more retraction features may retract the electrical connectors by accordioning, folding, bunching, compressing, or a combination thereof each electrical connector within a potting well, a protective stowage pocket, or both. The retraction feature may be a manual feature (e.g., a lever that the user slides in a retract direction that moves the electrical connector in the retract direction) and/or mechanically assists. The retraction feature may be a spring; a spring loaded spindle; a spring loaded linear slide; a slide that includes a bias member (e.g., a spring, elastic, or the like); or a combination thereof that assists in moving all or a portion of the one or more electrical connector back into the potting well, the protective stowage pocket, or both.

The one or more electrical connectors may be any device that conducts power between two or more busses, two or more photovoltaic components, or both. The one or more electrical connectors may be integral, removable, movable, may be connected on one side, may be movable one side, or a combination thereof. Preferably, at least one side of the electrical connectors is an integral part of the solar component, forms a fixed connection inside of the protective stowage pocket so that the electrical connector cannot be moved, or both. The one or more electrical connectors may be any part of a photovoltaic component that may be extended from one buss to another buss, from one photovoltaic component to another photovoltaic component, or both so that an electrical connection is formed. The electrical connector may be any device and/or feature that is movable from a protective stowage pocket to an adjacent photovoltaic component so that an electrical connection is formed between two or more photovoltaic components. Each photovoltaic component may include an electrical connector in one edge region and a connection port in an adjacent edge region. The photovoltaic components may include an electrical connector in each edge region and be free of connection ports. For example, one photovoltaic component may include two electrical connectors and a photovoltaic component with two connection ports may be located on each side of the photovoltaic component with two electrical connectors. The one or more electrical connectors may be made of any material so that power is conducted when a connection is formed. The one or more electrical connectors may be made of a composite of materials. The composite of materials may be any composite such that the electrical connectors conduct power. The composite may include a metal base material that conducts power and a support material that substantially encases the metal so that the support material provides flexibility, insulation, water resistance, electrical isolation, elastic malleability, provides bending resistance to the metal base material, or a combination thereof. The metal may be and/or include gold, copper, brass, bronze, tin, silver, or a combination thereof. The support material may be a polymer, plastic, rubber, include an elastomer, or a combination thereof. Preferably, the one or more electrical connectors include a silver or copper conductor that is coated by a material including an elastomer. The electrical connector, for example, may include two wires that are located in a single support material so that the two wires are electrically isolated, Insulated, or both. The metal base material may be one or more flexible conductors that conduct power through the photovoltaic component. The flexible conductors may be wires, power connectors, flat conductors, or a combination thereof. In addition to the electrical connectors including flexible materials, the one or more electrical connectors may be located in a flexible housing and/or the flexible material may be the flexible housing.

The flexible housing may be any portion of the electrical connectors that assists the electrical connector in aligning with a connection port that is misaligned, offset, out of line, out of plane, or a combination thereof; curving; bending; stretching; forming an arc; or a combination thereof so that an electrical connection is formed between two adjacent photovoltaic components, two adjacent buss bars, or both. The entire electrical connector may include a flexible housing. The flexible housing may be flexible substantially within a plane (i.e., flexed along a surface so that the electrical connector is within about 10 degrees or less, about 8 degrees or less, or about 5 degrees or less of the surface) and not flexible out of a plane, along a surface of the photovoltaic components, or both. The flexible housing may be flexible due to material characteristics. For example, the flexible housing may be made of and/or include plastic, rubber, a polymer, polyethylene, cross-linked polyethylene, polypropylene, polyurethane, polyvinyl chloride, silicone, or a combination thereof. The flexible housing may be made of a flexible material and include features that provide flexibility to the flexible housing. The flexible housing may be made of a substantially rigid material and include features that provide flexibility to the flexible housing.

The features that provide flexibility may be a strain relief feature. The strain relief feature may be a cut, a slit, an absence of material, a recess, a thinning of material, a through hole, or a combination thereof that forms one or more flexible portions in the flexible housing. The strain relief features may limit the position of the electrical connector. For example, when recesses are used, the recesses may be substantially closed when the flexible housing is displaced in a direction that places them into compression. In this example, the opposing edges of the recess are made to contact each other, forcing the strain to another area of the flexible housing. These strain relief features may be used to maintain a position within a pocket, or force a position to a mating position. Each strain relief feature may provide about 1 degree or more, 2 degrees or more, or about 3 degrees or more of flexibility. Each strain relief feature may provide about 10 degrees or less, about 8 degrees or less, or about 6 degrees or less of flexibility. For example, if the flexible housing includes 10 strain relief features and each strain relief feature allows for 1 degree of bend the flexible housing may be moved 10 degrees either direction along a plane. The collective strain relief features may be flexed so that the flexible housing extends from a connection point and forms an angle of about 5 degrees or more about 10 degrees or more, about 15 degrees or more, or about 20 degrees or more when an electrical connection is formed, when located in the protective stowage pocket, or both. The collective stain relief features may be flexed so that the flexible housing extends from a connection point and forms an angle of about 270 degrees or less, about 180 degrees or less, about 150 degrees or less, preferably about 135 degrees or less, more preferably about 105 degrees or less, and most preferably about 90 degrees or less when an electrical connection is formed, when located in the protective stowage pocket, or both. The strain relief features may provide flexibility to the electrical connector so that the electrical connector may lengthen and shorten. The flexible housing may include a plurality of strain relief features. The flexible housing may include one or more strain relief features, five or more strain relief features, or ten or more strain relief features. The flexible housing may include 50 or less, 40 or less, or 30 or less strain relief features. The strain relief features may be symmetrically located, asymmetrically located, staggered, on one side, on both sides, or a combination thereof on the flexible housing. The strain relief features may allow for movement of the electrical connection during movement from a storage position to an electrical connection position, during thermal expansion of one or more photovoltaic components, movement of one or more photovoltaic components, or a combination thereof. The electrical connector may lengthen and shorten by varying an arc, an angle, curve, or a combination thereof. The one or more electrical connectors include a length.

The length of the one or more electrical connectors may be any length so that the electrical connectors extend from a photovoltaic component, a buss, or both and extend to an adjacent photovoltaic component, an adjacent buss, or both. Preferably, the length of the electrical connector is sufficient so that the electrical connector extends from a stowage pocket, is removable from the protective stowage pocket, is removable from a stowage recess, or a combination thereof over a portion of an adjacent photovoltaic component and forms an electrical connection with the adjacent photovoltaic component. The length of the one or more electrical connectors may be about 1 cm or more, about 5 cm or more, about 10 cm or more, or even 15 cm or more. The length of the one or more electrical connectors may be about 50 cm or less, about 30 cm or less, or about 20 cm or less. Each electrical connector includes a height.

The height of each electrical connector may be any height so that an electrical connection may be formed. The height of each electrical connector may be sufficiently small so that each electrical connector is flush when an electrical connection is formed. The height may be sufficiently small so that an electrical connector is low profile. The height may be substantially equal to that of the connection port so that when the electrical connector is extended into the connection port the electrical connector is flush with all or some of the portions of the photovoltaic component surrounding the connection port. The height of each electrical connector may be sufficiently large so that power may be transferred from one photovoltaic component to another photovoltaic component, one buss bar to another buss bar, or both. The height may be about 1 mm or more, about 2 mm or more, or even about 3 mm or more. The height may be about 3 cm or less, about 2 cm or less, or about 1 cm or less. The electrical connector may include one or more locks that assist in forming a connection with an adjacent photovoltaic component, an adjacent buss bar, or both.

The one or more locks may be any device that connects the electrical connector to a buss bar, an adjacent photovoltaic component, or both. The one or more locks may be located on an end, side, edge, or a combination thereof. Preferably, a lock is located on a bottom side of the electrical connector so that when the electrical connector extends over the photovoltaic module the lock forms a connection with a location portion in the connection port. The lock may be located and/or configured so that the lock resists and/or prevents the electrical connector to move in plane, but the lock may release the connection with the electrical connector if moved out of plane (e.g., away from the photovoltaic component). The lock may be any device that physically connects, electrically connects, or both the electrical connector to an adjacent photovoltaic component, a connection port, or both so that the physical connection, the electrical connection, or both is retained if the photovoltaic components move relative to each other. The one or more locks may be a recess, a hole, a projection, a clip, a pin, a male portion, a female portion, a buckle, or a combination thereof. Preferably, the lock is a projection that extends into a lock port that is a recess to form an electrical connection, a physical connection, or both. The one or more locks may be any device and/or feature that forms an electrical connection, a physical connection, or both with an adjacent photovoltaic component, a connection port, a lock port, or a combination thereof.

The lock port may be any portion and/or feature that is complementary to a lock on the electrical connector and assists in forming a physical connection, an electrical connection, or both. The lock port may be located at any location on a photovoltaic component, a connection port, or both. The lock port may be located on an electrical connector. The lock port may be static, movable, or both. The lock port located on an electrical connector may include a flexible housing and be movable substantially within a plane as discussed herein with regard to a flexible housing an strain relief feature the teachings of both incorporated herein for a movable lock port. The lock port may receive the lock or vice versa. The lock may be a recess, a hole, a pin, a clip, a buckle, a male portion, a female portion, a buckle, or a combination thereof. The lock port may form a physical connection, an electrical connection, or both. Preferably, the lock port and the lock form a physical connection and the physical connection assists in forming the electrical connection. The lock port may be located at any location on a photovoltaic component. More preferably, the lock port is located within the connection port.

The connection port may be any part of the photovoltaic component that forms a physical connection, an electrical connection, or both with an electrical connector. The connection port may be any device and/or feature that receives all or a portion of an electrical connector so that the electrical connector electrically connects two or more adjacent photovoltaic components. The connection port may be a recess, a hole, a channel, or a combination thereof that may receive an electrical connector. The connection portion may be located in an inactive portion, an active portion, a top side, a bottom side, an edge, a central region, an edge region, or a combination thereof. The connection port may begin at an edge and extend inwardly towards a center of the photovoltaic component. The connection port may extend a full width and/or length of an edge region. Preferably, the connection port is located on the photovoltaic component so that the connection port is aligned with the electrical connections. The connection port may be open to the environment, partially closed so that the electrical connector may be placed in the connection port and partially protected from the environment, include a cover that covers the electrical connector so that the connection port and electrical connector are protected from the surrounding environment, or a combination thereof.

The electrical connection may be any connection so that power may be transferred from one photovoltaic component to another photovoltaic component. The electrical connector may only form an electrical connection and another device may form the physical connection, the electrical connector may form both an electrical connection and a physical connection. The electrical connector may assist in forming an electrical connection and assist in forming an additional physical connection, or a combination thereof. The electrical connector may be movable substantially along a plane, substantially within a plane, or both (i.e., movable so that the electrical connector forms an angle of about 10 degrees or less, about 8 degrees, or less, about 5 degrees or less, preferably about 3 degrees or less, or more preferably about 1 degree or less) from a storage position to an electrical connection position. The electrical connection may be movable substantially along a plane, substantially within a plane, or both when in an electrical connection position so that the electrical connector moves with the photovoltaic component and an adjacent photovoltaic component during thermal expansion, movement, or both of one or more photovoltaic components.

A photovoltaic array may be formed by a method. The method may include installing photovoltaic components to form a photovoltaic array. The method of forming a photovoltaic array may be performed in any order taught herein. The method may include a step of forming a stored position by putting the electrical connector in the protective stowage pocket, locking the electrical connector in the protective stowage pocket, pulling the electrical connector out of a protective stowage pocket, pulling an electrical connector having a connection port out of a protective stowage pocket, or a combination thereof so that the photovoltaic component may be transported. A plurality of photovoltaic components may be moved to an elevated position. Each of the plurality of photovoltaic components may be connected directly to a support structure, aligned relative to one or more adjacent photovoltaic components, overlap all or a portion of one or more adjacent photovoltaic components, engage one or more optional mating features, or a combination thereof. The photovoltaic components may be aligned so that an active portion of one component overlaps an inactive portion of one or more adjacent photovoltaic components. The electrical connector may be disconnected form the protective stowage pocket, the electrical connector may be moved from a storage position to an electrical connection position, or both. The electrical connector including a lock may be moved to the lock port, the electrical connector including a lock port may be moved to the lock, an electrical connector with a lock port and an electrical connector with a lock may be simultaneously moved towards each other until an electrical connection is formed. The electrical connector may be aligned with a connection port, the electrical connector may be installed in the connection port, a lock of the electrical connector may be placed in a lock port of the connection port, or a combination thereof.

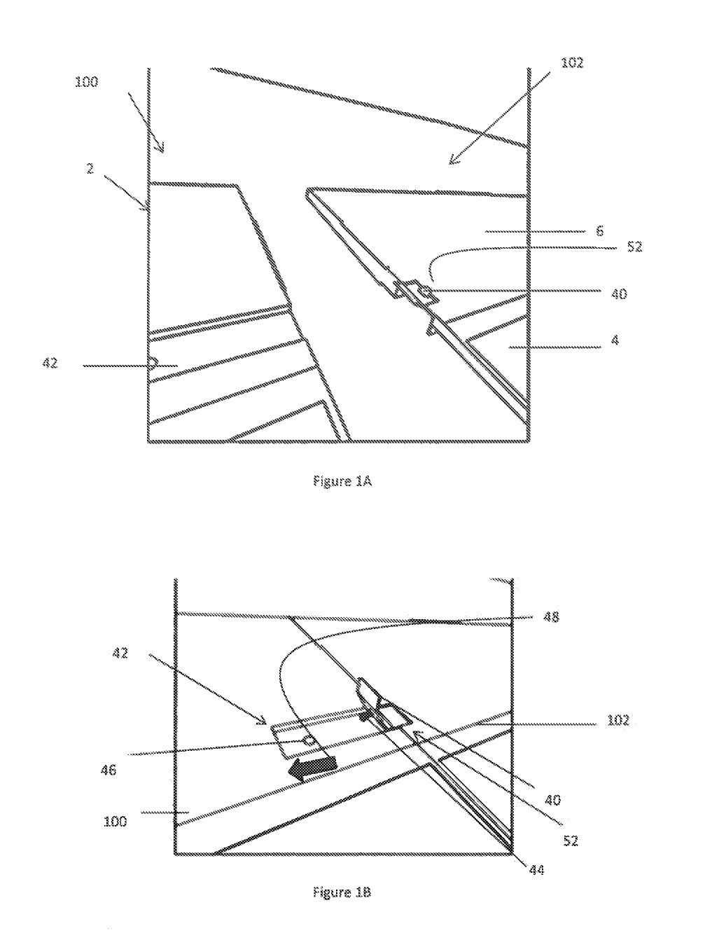

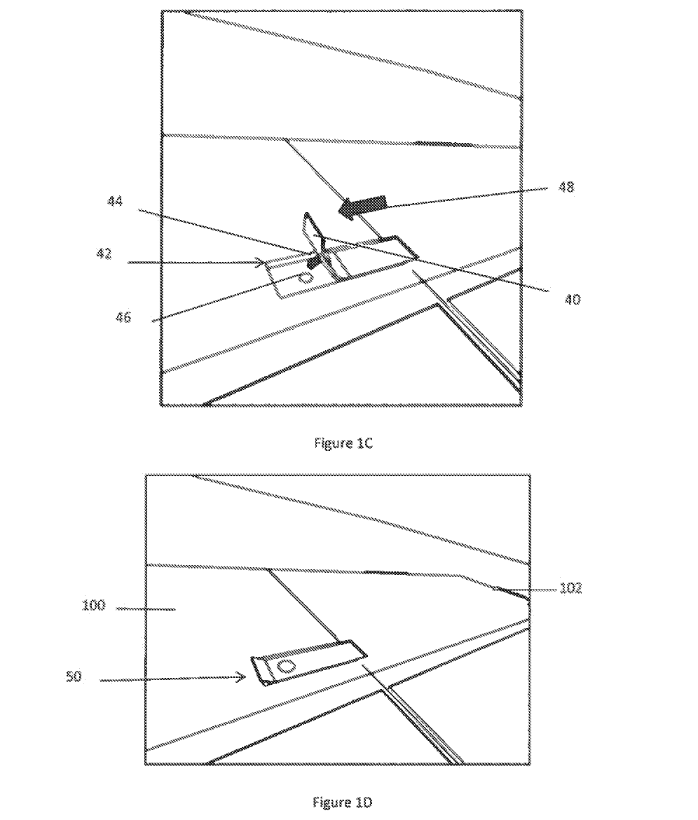

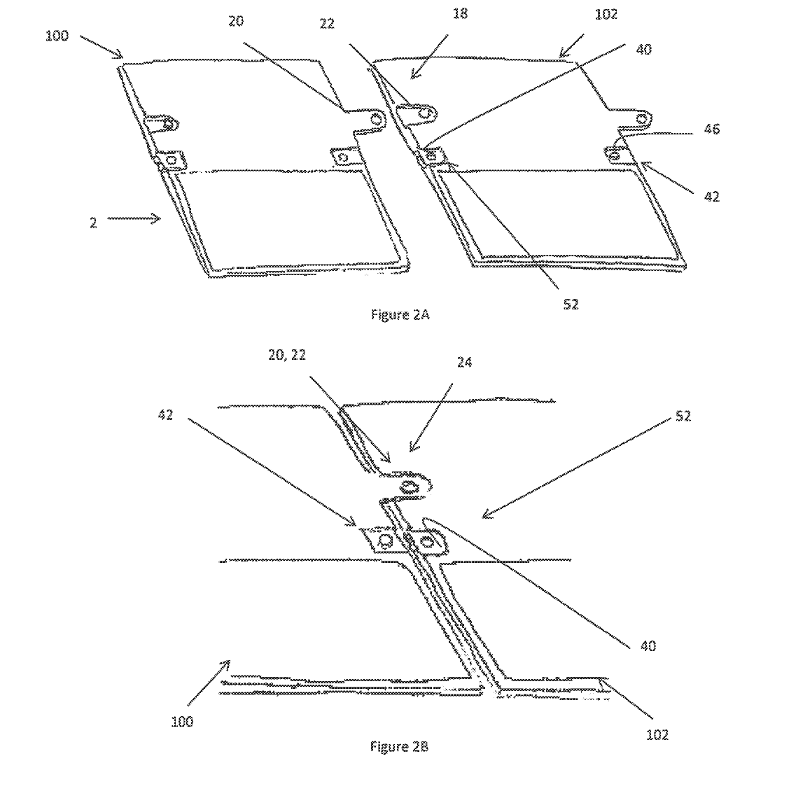

FIGS. 1A-1D illustrate a sequence to form an electrical connection. FIG. 1A illustrates a photovoltaic component 100 that is a photovoltaic module 2 and an adjacent photovoltaic component 102. Each of the photovoltaic components 100, 102 includes an active portion 4 and an inactive portion 6. The inactive portion 6 of the adjacent solar component 102 includes an electrical connector 40 is located inside of a protective stowage pocket 52. The electrical connector 40 is located directly across from a connection port 42 in the solar component 100 so that when the electrical connector 40 is extended an electrical connection is formed.

FIG. 1B illustrates the electrical connector 40 extending from the protective stowage pocket 52 of the adjacent photovoltaic component 102 towards the connection port 42 in the solar component 100. The connection port 42 includes a lock port 46 that receives a lock 44 on the electrical connector 40 so that the electrical connector 40 electrically connects the photovoltaic components 100, 102.

FIG. 1C illustrates the electrical connector 40 being extended in the direction 48 and the lock 44 is about to be placed in the lock port 46 of the connection port 42.

FIG. 1D illustrates an electrical connection 50 formed between the photovoltic component 100 and the adjacent photovoltaic component 102.

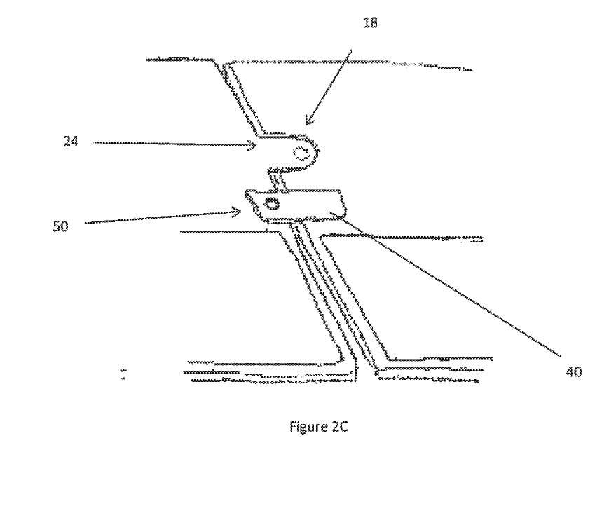

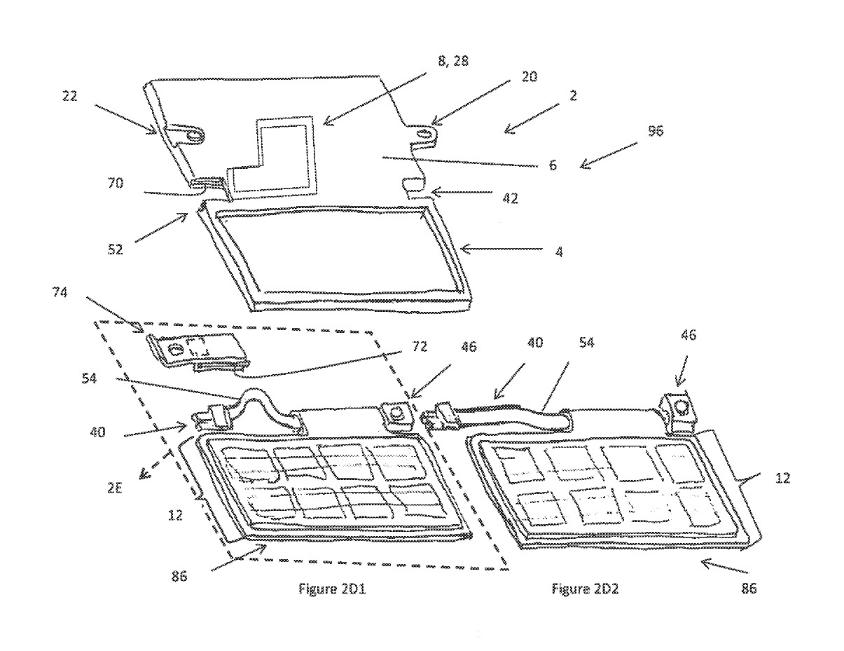

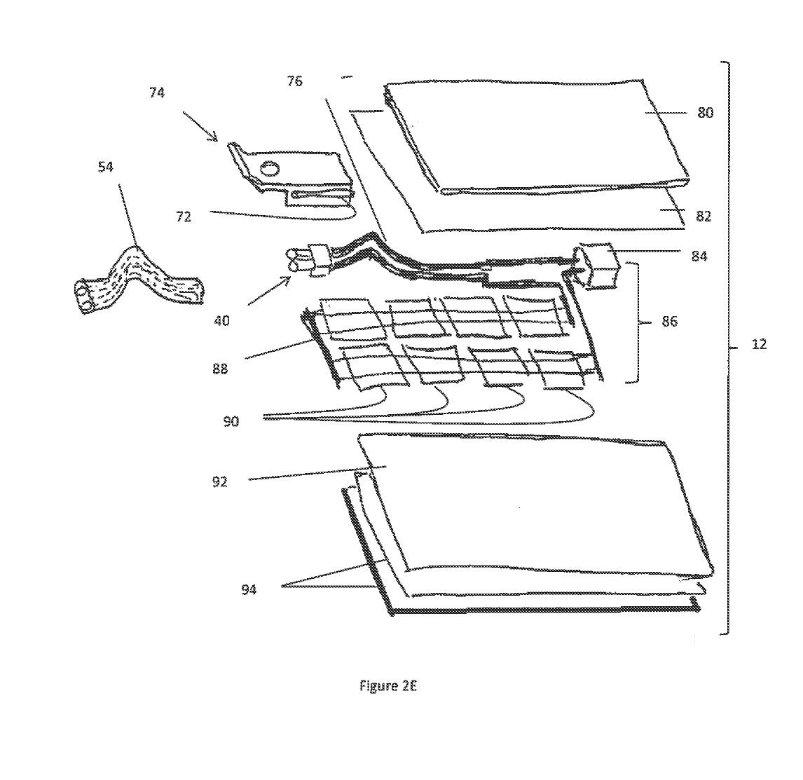

FIGS. 2A through 2C illustrate a sequence to form an electrical connection 50 and a mating connection 24 between two photovoltaic components 100, 102. FIG. 2A illustrates two photovoltaic components 100, 102, one of which is a photovoltaic module 2. An adjacent photovoltaic component 102 includes an electrical connector 40 within a protective stowage pocket 52. The electrical connector 40 is locked within a protective stowage pocket 52 when in the uninstalled position so that the connector 40 is protected from damage. The photovoltaic component 100 includes a connection port 42 with a lock port 46 where the electrical connector 40 is placed to form an electrical connection. The photovoltaic components 100 and 102 include mating features 18. The mating feature 18 on the photovoltaic component 100 is a male portion 20 and the mating feature 18 on the adjacent photovoltaic component 102 has a female portion 22 for forming a mating connection.

FIG. 2B illustrates the two photovoltaic components 100, 102 that are connected by a mating connection 24 between a male portion 20 and a female portion 22. As illustrated, the electrical connector 40 and the connection port 42 are aligned so that when the electrical connector 40 is removed from the protective stowage pocket 52 an electrical connection may be formed.

FIG. 2C illustrates the mating features forming a mating connection and the electrical connector 40 extended forming an electrical connection 50.

FIGS. 2D1 and 2D2 illustrate an exploded view of a photovoltaic module 2 with the laminate assembly 12 and electric assembly 86 removed from the photovoltaic housing 96 (as illustrated only one photovoltaic housing 96 is being shown for both FIGS. 2D1 and 2D2). FIG. 2D1 illustrates the laminate assembly 12 and electric assembly 86 being removed from a photovoltaic housing 96 with the electrical connector 40 shown in a retracted state. FIG. 2D2 illustrates the laminate assembly 12 and electric assembly 86 removed from the photovoltaic housing 96 with the electrical connector 40 shown in an extended state. The photovoltaic housing 96 of FIGS. 2D1 and 2D2 includes a female portion 22 for forming a mating connection with an opposing male portion 20 of an adjacent photovoltaic component (not shown). A male portion 20 extends from the photovoltaic housing 96 from an opposite edge region as the female portion 22. A connection port 42 is located below the male portion 20 on the inactive portion 6 directly above the active portion 4. The protective stowage pocket 52 has a potting well 8 forming a stowage recess 28 so that the electrical connector 40, including additional length of the electrical connector 40, can be retracted into the photovoltaic housing 96 in the recessed state (as shown in 2D1). The photovoltaic housing 96 includes a protective stowage pocket 52 having a track 70 so that a projection 72 of connector slide cover 74 extends into the track 70 so that the connector slide cover 74 including the electrical connector is movable along the track 70 of the protective stowage pocket 52.

The connector slide cover 74 connects to the flexible housing 54 of the electrical connector 40 so that the connector slide cover 74 may be used to extend and retract the electrical connector within and along the protective stowage pocket 52. Opposing the electrical connector 40 along the top of the laminate assembly 12 a lock port 46 is connected so that power can extend along a length of the photovoltaic module 2 from one photovoltaic module to an adjacent photovoltaic module. The laminate assembly 12 includes an electrical assembly 86 therein for generating power when exposed to sunlight.

FIG. 2E is an exploded view of the laminate assembly 12 of FIG. 2D1. The laminate assembly 12 includes a front layer 80 and an encapsulate layer 82 extending over a top side of the laminate assembly 12 for providing protection and water resistance for the electric assembly 86. The electric assembly 86 includes busses 88 extending along a plurality of photovoltaic cells 90. The busses 88 are electrically connected to both the female connector 84 and the electrical connector 40 so that power is transferred from and through the photovoltaic module. The electrical connector 40 is covered by a flexible housing 54 and a connector slide cover 74 for protecting the flexible conductors 76 of the electrical connector 40. Below the electrical assembly 86 there are an encapsulant layer 92 and a pair of back layers 94 for providing protection and water resistance for the electric assembly 86.

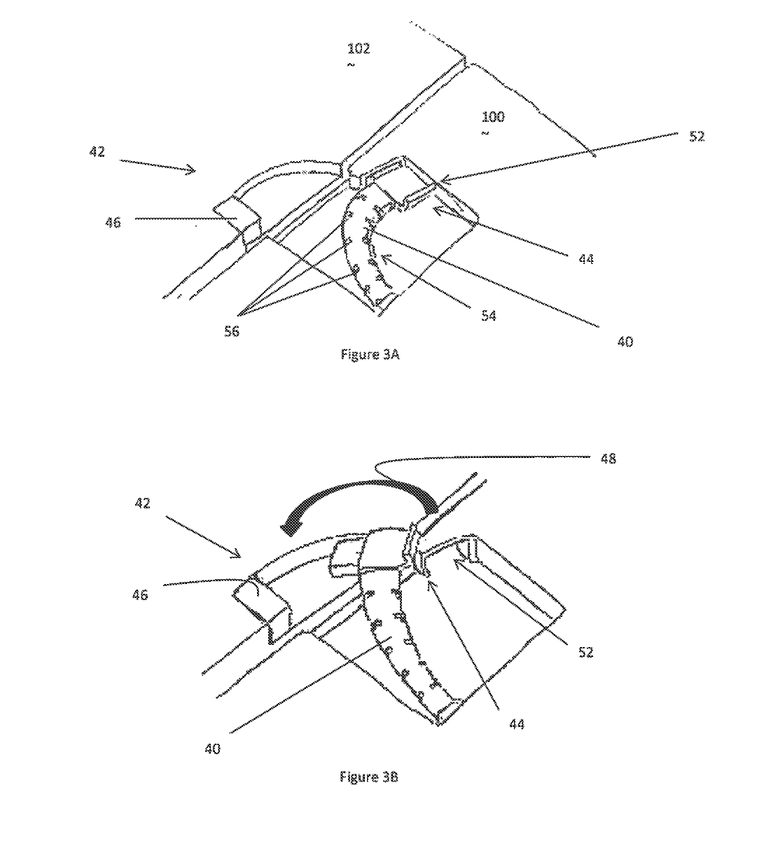

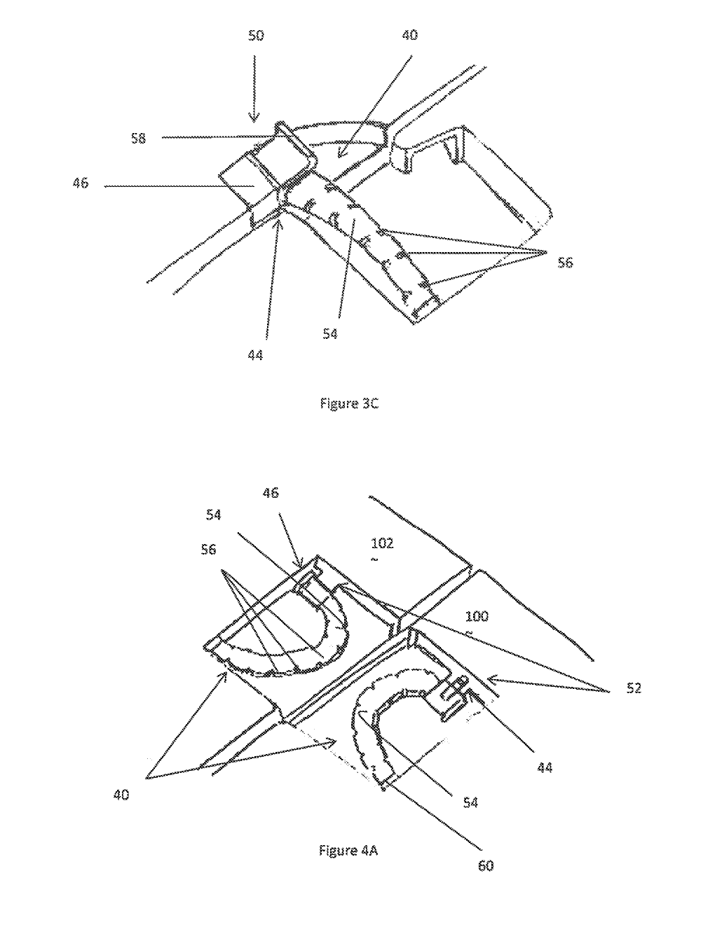

FIG. 3A-3C illustrate an example of another electrical connector 40 and protective stowage pocket 52 of the teachings herein. As illustrated in FIG. 3A, the photovoltaic component 100 includes a protective stowage pocket 52 retaining the electrical connector 40. The electrical connector 40 includes a flexible housing 54 including a plurality of strain reliefs 56. The adjacent photovoltaic component 102 includes a connection port 42 including a lock port 46 for receiving a lock 44 of the electrical connector 40.

FIG. 3B illustrates the electrical connector 40 having the lock 44 released from the protective stowage pocket 52 so that the electrical connector 40 may be moved in the direction 48. As the electrical connector 40 is moved in the direction 48 the electrical connector 40 is moved into the connection port 42 until the electrical connector is locked into the lock port 46.

FIG. 3C illustrates the electrical connector 40 locked into the lock port 46. The electrical connector 40 includes a lock release feature 58 that releases the lock 44 so that the electrical connector 40 can be removed from the lock port 46. The flexible housing 54 of the electrical connector 40 is straightened via the strain relief features 56 so that the electrical connector 40 is moved to form an electrical connection 50.

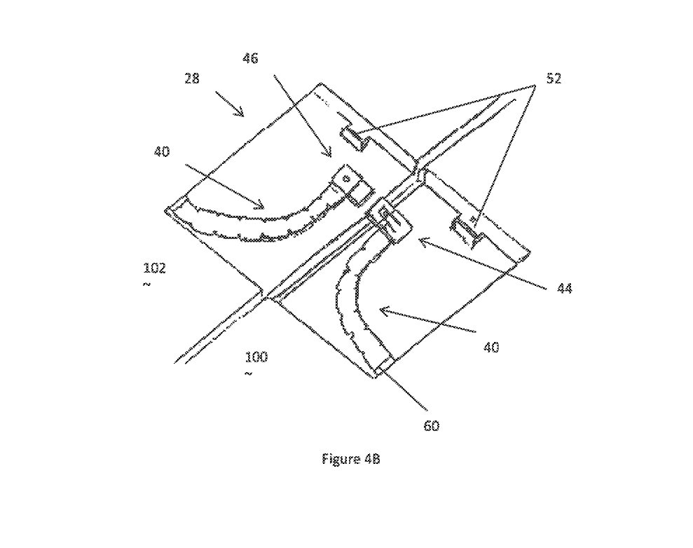

FIGS. 4A and 4B illustrate a solar component 100 and an adjacent solar component 102 located next to each other. In FIG. 4A, the solar component 100 and the adjacent solar component 102 both include a protective stowage pocket 50 and an electrical connector 40. Both of the electrical connectors 40 include a connection point 60 and include a flexible housing 54 that has a plurality of strain relief features 56. The electrical connector 40 on the solar component 100 includes a lock 44 that connects the electrical connector 40 in the protective stowage pocket 52 in the stored configuration and in the lock port in the electrical connection configuration. The electrical connector 40 on the adjacent solar component 102 includes a lock port 46 so that lock 44 on the electrical connector 40 on the solar component 100 can form a connection when the two electrical connectors 40 are moved into a connection.

In FIG. 4B the electrical connectors 40 are removed from the protective stowage pockets 52. The electrical connectors 40 extend from a connection point 60 and are moved within the stowage recess 28 along a plane of the respective photovoltaic component 100 and adjacent photovoltaic component 102 so that an electrical connection is formed when the two electrical connectors are moved into contact and the lock 44 forms a connection with the lock port 46.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1) A photovoltaic component comprising:
a protective stowage pocket integrally formed in the photovoltaic component;
an integral electrical connector located inside of and housed within the protective stowage pocket during a storage position so that the integral electrical connector is protected when in an uninstalled position, and wherein the protective stowage pocket sufficiently confines the integral electrical connector so that the electrical connector is prevented from moving during transportation;
one or more photovoltaic cell that are electrically connected to the integral electrical connector;
wherein the electrical connector is movable from the protective stowage pocket to an electrical connection position where the electrical connector electrically connects the photovoltaic component to an adjacent photovoltaic component, and
wherein the photovoltaic component includes a connection port along one edge region and the electrical connector along an opposing edge region.

2) The photovoltaic component of claim 1, wherein the connection port includes a lock port and the electrical connector includes a lock that extends into the lock port so that the electrical connector forms a fixed connection and remains extended.

3) The photovoltaic component of claim 1, wherein substantially all of the electrical connector is located within the protective stowage pocket when the electrical connector is in the stored position.

4) The photovoltaic component of claim 1, wherein the electrical connector is movable substantially along a plane from the storage position to an electrical connection position so that the electrical connector moves with the photovoltaic component and/or the adjacent photovoltaic component during thermal expansion, movement, or both.

5) The photovoltaic component of claim 1, wherein the electrical connector is movable substantially along a plane of the photovoltaic component to remove the electrical connector form the protective stowage pocket.

6) The photovoltaic component of claim 1, wherein the connection port is a recess and the electrical connector fits within the recess so that a top of the electrical connector is flush with a top of the adjacent photovoltaic component, a cover can be placed over the electrical connector and the cover is flush with the top of the photovoltaic component, or both.

7) The photovoltaic component of claim 1, wherein an end of the electrical connector forms a fixed connection inside of the protective stowage pocket so that the end cannot be moved.

8) The photovoltaic component of claim 1, wherein the electrical connector includes a flexible housing so that the electrical connector is movable along a surface of the photovoltaic component towards and over a portion of the adjacent photovoltaic component so that an electrical connection is formed between the photovoltaic module and the adjacent photovoltaic module.

9) The photovoltaic component of claim 8, wherein the flexible housing includes strain relief features so that electrical conductors housed in the flexible housing are protected during movement of the photovoltaic module, movement of the electrical connector, thermal expansion of the photovoltaic module, thermal expansion of an adjacent photovoltaic module, movement of the mounting structure, or a combination thereof; and
wherein the strain relief features allow the flexible housing to move at an angle along a plane so that the flexible housing forms an angle of about 5 degrees or more measured from a connection point on the photovoltaic component and the strain relief features limit the movement along the plane so that the flexible housing is limited in forming an angle of about 180 degrees or less measured form a connection point on the photovoltaic component.

10) The photovoltaic component of claim 1, wherein the electrical connector includes a lock that locks the electrical connector in the protective stowage pocket during transportation and movement of the photovoltaic module so that the protective stowage pocket protects the electrical connector from damage and/or so that the lock locks the electrical connector into a lock port of an adjacent photovoltaic module for forming the electrical connection.

11) The photovoltaic component of claim 1, wherein the electrical connector that forms an electrical connection between the photovoltaic component and the adjacent photovoltaic component is movable along a plane of the photovoltaic component, the adjacent photovoltaic component, or both so that the electrical connector compensates for movement between the photovoltaic component and the adjacent photovoltaic component, thermal expansion of the photovoltaic component, thermal expansion of the adjacent photovoltaic component, thermal expansion of the mounting structure, or a combination thereof.

12) A photovoltaic array comprising: a plurality of the photovoltaic components of claim 1, wherein some of the plurality of photovoltaic components are photovoltaic modules.

13) The photovoltaic array of claim 12, wherein the connection port is fixed and the electrical connector is movable.

14) The photovoltaic array of claim 12, wherein the connection port is part of an electrical connector having a flexible housing and the electrical connector has a flexible housing so that the connection port and the electrical connector are movable to form an electrical connection.

15) A method of installing the photovoltaic components of claim 1 comprising:
a. aligning two or more photovoltaic components adjacent to each other;
b. pulling the electrical connector from the protective stowage pocket in the photovoltaic component and extending the electrical connector over an adjacent photovoltaic component; and
c. forming an electrical connection between the photovoltaic component and the adjacent photovoltaic component.
